(19) United States
(12) Patent Application Publication
(10) Pub. No.: US 2006/0195399 A1
(43) Pub. Date: Aug. 31, 2006

(54) System and method for interrelating and storing advertisements, tearsheets, and invoices

(76) Inventors: David M. Tenenbaum, Hingham, MA (US); Andrew Forber, Mississauga (CA); Christine Forber, Mississauga (CA); Chris Carr, Coupeville, WA (US); Mark White, Vancouver (CA)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/398,976

(22) Filed: Apr. 6, 2006

Related U.S. Application Data
(62) Division of application No. 10/431,778, filed on May 7, 2003.

(51) Int. Cl. G06Q 40/00

(52) U.S. Cl. 705/40; 705/34

(57) ABSTRACT

A website including a search web page configured to search for invoices and to display a web page with at least one found invoice summary. There is a link between the at least one found invoice summary and an invoice which, when activated, displays a web page with an invoice including at least one line item for an advertisement in a publication, and a link between the at least one line item and a tearsheet for the advertisement which, when activated, displays a web page with the tearsheet along with metadata regarding the tearsheet.

### RELATED APPLICATIONS AND PRIORITY CLAIM

This application is a divisional application of prior U.S. patent application Ser. No. 10/431,778 filed on May 7, 2003, which is hereby incorporated herein by reference, and to which this application claims priority.

### FIELD OF THE INVENTION

This invention relates to a system and method useful for interrelating and storing advertisements, tearsheets, and invoices.

### BACKGROUND OF THE INVENTION

The publishing industry generates revenue by advertising: companies or their advertising agencies create advertisements and pay publishers to run the advertisement in their publications or sometimes the publication creates the advertisement. The company or agency is then invoiced and provided with a copy of the page of the publication where the advertisement appeared (the “tearsheet”) allowing the company or the agency to verify that the advertisement appeared as requested and as invoiced. Hereinafter, the companies who place advertisements and the advertising agencies who do so on their behalf will be collectively called “advertisers”.

The applicant has long archived publications, tearsheets, and advertisement information on behalf of publishers in digital form. Recently, efforts have been made to automate the invoicing process. For example, U.S. Pat. No. 6,505,173 discloses a system wherein the original advertisement, the tearsheet, and the invoice are all stored in the same computer file so that all three items can be provided to the advertiser.

Still, even with such a system, the full utility of the Internet, websites, hyperlinks, XML, and PDF files is not utilized.

Besides placing advertisements, publishers or their contractors also offer a service to advertisers wherein an advertiser is provided with reports of advertisements placed by the advertiser's competitors. In this way, General Motors, for example, can monitor advertisements placed by Ford and vice versa. Performing these services, currently a manual process, is time consuming and expensive.

Publishers too monitor the competition. Thus, a service industry has developed which monitors the advertisements placed in competitive publications. In this way, the Boston Globe, for example, can ascertain which companies place advertisements in the Boston Herald as opposed to The Boston Globe. Again, these services, carried out manually, are time consuming and expensive.

### SUMMARY OF THE INVENTION

It is therefore an object of this invention to provide a system and method for interrelating and storing advertisements, tearsheets, and invoices.

It is a further object of this invention to provide a system and method which better utilizes the Internet and the features of a website to provide advertisers with a better way to associate invoice line items with advertisements and tearsheets.

It is a further object of this invention to provide such a system and method which makes it easier for advertisers to verify that an advertisement appeared in a publication as requested and as invoiced.

It is a further object of this invention to provide tearsheets viewable on-line along with metadata related to an advertisement on the tearsheet.

It is a further object of this invention to provide such a system and method which also allows an advertiser to more easily monitor a competitor's advertisements.

It is a further object of this invention to provide such a system and method which also allows publishers to more easily monitor advertisers using competitive publications.

The invention results from the realization that by establishing a website with the ability to search for invoices and by providing a hyperlink between each invoice line item and the corresponding tearsheet for that line item, advertisers can now associate, check, and verify that their advertisements appeared in a given publication as requested and as invoiced in a much easier and convenient fashion. And, the same system which archives the invoices, the advertisement information, and the tearsheets now makes it possible for an advertiser to more easily monitor a competitor's advertisements and also makes it possible for a publisher to more easily monitor advertisers using competitive publications.

This invention features an invoice displayed on a website, the invoice comprising at least one line item for an advertisement in a publication and a link between the line item and a tearsheet for the advertisement that when activated, causes the display of the tearsheet. Typically, the link is a hypertext link. In one example, the line item includes an advertisement identifier, the publication date, the publication, the advertiser, and the cost. Also, the tearsheet is usually displayed with metadata such as the name of the advertiser, the publication, the section, the page, a description, an advertisement identifier, the advertisement size, and the publication date. The website is searchable, inter alia, by publication, by advertiser, and/or by date.

The preferred system for interrelating and storing advertisements, tearsheets, and invoices in accordance with the invention includes a receiving portal for receiving electronic files representing the pages of a publication, electronic records of advertisements, and electronic records of invoices. An engine is responsive to the receiving portal and is configured to electronically interrelate and store the electronic files representing the pages of a publication, the electronic records of advertisements, and the electronic records of the invoices. A search routine is configured to search for invoices and/or tearsheets, and a display routine is configured to display found invoices and tearsheets in a way that interrelates an invoice line item with a tearsheet. In the preferred embodiment, the display routine displays the invoice with a link to the tearsheet which is displayed when the link is activated. Also, the display routine could be configured to display the tearsheet with a link to the invoice which is displayed when the link is activated typically, by an icon.

In one example, the electronic files representing the pages of the publication include a PDF file for selected pages of the publication, and the electronic record of an advertisement is an XML record containing metadata about the advertisement. In this example, the metadata includes an advertisement identifier, the name of the advertiser, the publication, the section, the page, a description, the advertisement size, and the publication date. Also included may be a process which stitches the metadata onto the tearsheet. Typically, the electronic record of the invoice is an XML record of the invoice.

One system for interrelating and storing advertisements, tearsheets, and invoices in accordance with the invention includes means for receiving electronic files representing the pages of a publication, electronic records of advertisements, and electronic records of invoices. There are means for electronically interrelating and storing the electronic files representing the pages of a publication, the electronic records of advertisements, and the electronic records of the invoices. There are also means for searching invoices and/or tearsheets and means for displaying found invoices and tearsheets in a way that interrelates an invoice line item with a tearsheet.

In one example, the means for displaying includes a screen displaying all found invoices by number. The means for displaying may further include a screen displaying an individual invoice selected from the found invoices. Preferably, the individual invoice includes line items each linked to a tearsheet corresponding to the invoice.

One method of interrelating and storing advertisements, tearsheets, and invoices in accordance with this invention includes receiving electronic files representing the pages of a publication, electronic records of advertisements, and electronic records of invoices. The electronic files representing the pages of a publication, the electronic records of advertisements, and the electronic records of the invoices are electronically interrelated and stored. The method further includes searching for specific invoices and/or tearsheets and displaying found invoices and tearsheets in a way that interrelates an invoice line item with a tearsheet. Typically, all found invoices are displayed by number and each are linked to an actual invoice displayed when the link is activated. Thus, each invoice is displayed with a link to the tearsheet which is displayed when the link is activated.

Also, the tearsheet may be displayed with a link to the invoice which is displayed when the link is activated. That link may be an icon. Typically, the electronic files representing the pages of the publication include a PDF file for selected pages of the publication, the electronic record of an advertisement is an XML record containing metadata about the advertisement (e.g., an advertisement identifier, the name of the advertiser, the publication, the section, the page, a description, the advertisement size, and the publication date), and the electronic record of the invoice is an XML record of the invoice.

Another system for interrelating and storing advertisements, tearsheets, and invoices in accordance with this invention features a receiving portal for receiving electronic files representing the pages of a publication, electronic records of advertisements, and electronic records of invoices, an engine responsive to the receiving portal configured to electronically interrelate and store the electronic files representing the pages of a publication, the electronic records of advertisements, and the electronic records of the invoices, a search routine configured to search for invoices and/or tearsheets, and a process configured to display a found tearsheet along with metadata concerning an advertisement on the tearsheet.

A method of interrelating and storing advertisements, tearsheets, and invoices in accordance with this invention features receiving electronic files representing the pages of a publication, electronic records of advertisements, and electronic records of invoices, electronically interrelating and storing the electronic files representing the pages of a publication, the electronic records of advertisements, and the electronic records of the invoices, searching for specific invoices and/or tearsheets, and displaying a found tearsheet with metadata concerning an advertisement on the tearsheet.

Also, information other than tearsheets may be linked to invoice line items in accordance with this invention: purchase orders, contractual documents, statements of work, pictures or advertisements of an invoiced line item product, and the like. Thus, a tearsheet is but one possible form of the supporting documentation linked to an invoiced line item in accordance with this invention.

### BRIEF DESCRIPTION OF THE DRAWINGS

Other objects, features and advantages will occur to those skilled in the art from the following description of a preferred embodiment and the accompanying drawings, in which:

FIG. 1 is an example of a website screen allowing a user to search for invoices;

FIG. 2 is an example of a website screen showing a set of invoices found pursuant to the criteria entered in the search screen of FIG. 1;

FIG. 3 is an example of a website screen displaying an actual invoice selected from the set of invoices displayed in FIG. 2;

FIG. 4 is a view of a tearsheet displayed on the website after a line item of the invoice of FIG. 3 is activated;

FIG. 5 is a block diagram showing the primary components and steps associated with the system and method for interrelating and storing advertisements, tearsheets, and invoices in accordance with the subject invention;

FIG. 6 is a flow chart depicting the primary processing steps associated with the data receiving portal of FIG. 5;

FIG. 7 is a flow chart depicting the primary processing steps associated with the engine of FIG. 5;

FIG. 8 is a flowchart depicting the primary steps associated with the method of stitching metadata onto the tearsheet in accordance with the subject invention;

FIGS. 9-10 are flow charts depicting the primary steps associated with allowing an administrator to add new users and the like to the system of this invention; and

FIG. 11 is a screen shot showing metadata stitching onto the left edge of a PDF version of a tearsheet in accordance with the subject invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

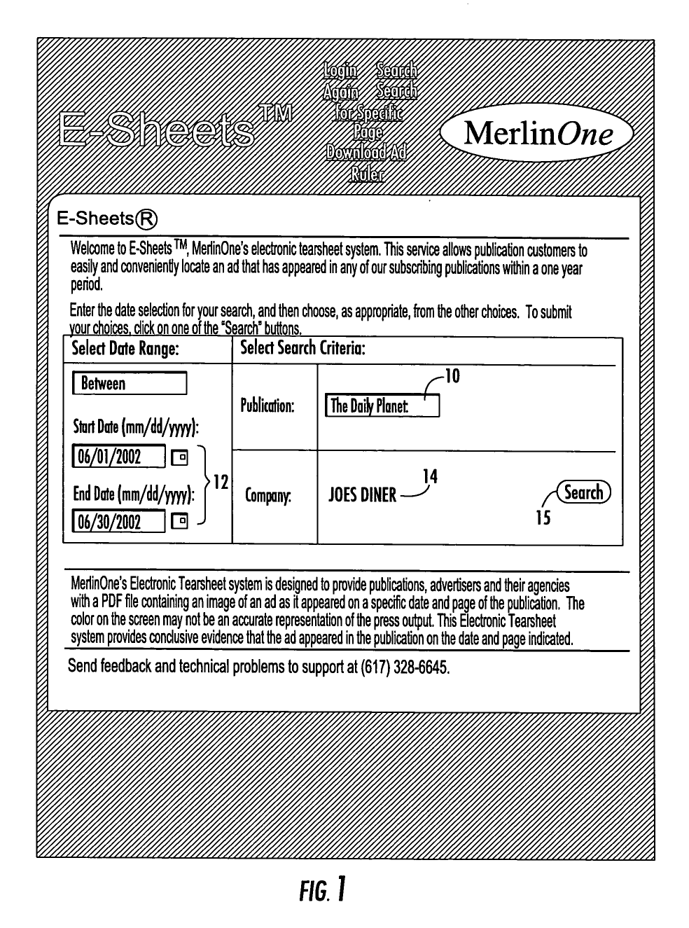

One aspect of the subject invention features a website accessible over the world wide web which allows advertisers to search for, inter alia, invoices using, for example, the search screen of FIG. 1 wherein an advertiser can search for invoices in a particular publication 10 concerning a specific time period 12 relating to a specific agency and/or company 14. The ability to conduct such searches can be a revenue generating service offered to publishers and/or their advertiser customers.

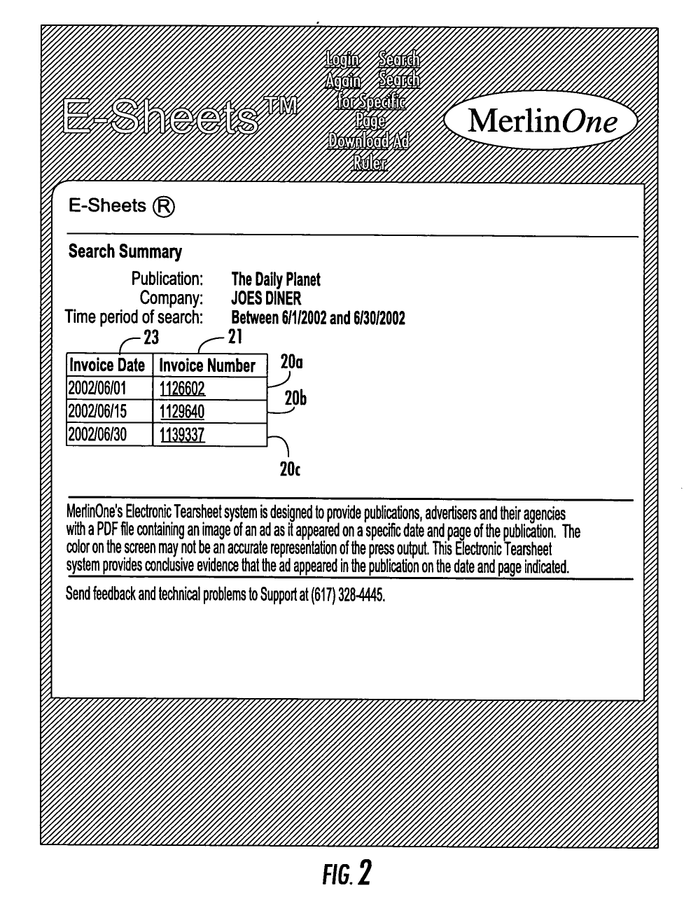

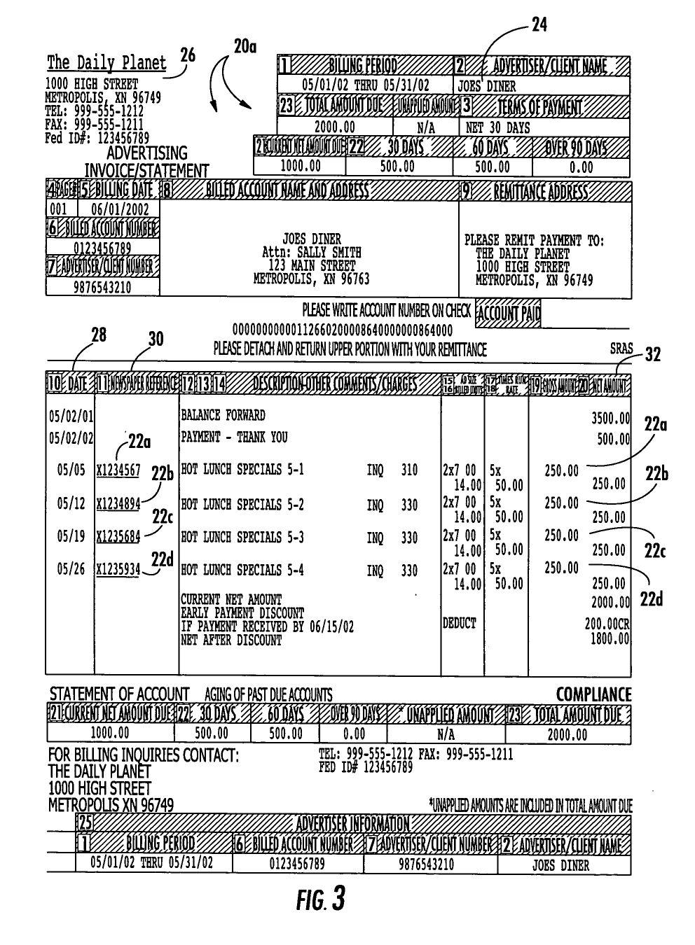

After the user activates server icon or button 15, the search means, engine, or routine(s) of the subject invention then finds all stored invoices meeting the criteria entered in FIG. 1 and, in this example, displays found invoices 20a, 20b, and 20c, FIG. 2 each including an invoice number 21 and date 23. By clicking on invoice 20a, the system of the subject invention displays that invoice as shown in FIG. 3. Thus, each invoice displayed by number in FIG. 2 is linked to an actual invoice by the system of this invention. Invoice 20a, FIG. 3, in turn, includes line items 22a-d and the name of the specific company (advertiser) 24, the publisher 26, the publication date 28, the advertisement identifier 30 (e.g., a unique number and or letter combination) and the cost 32.

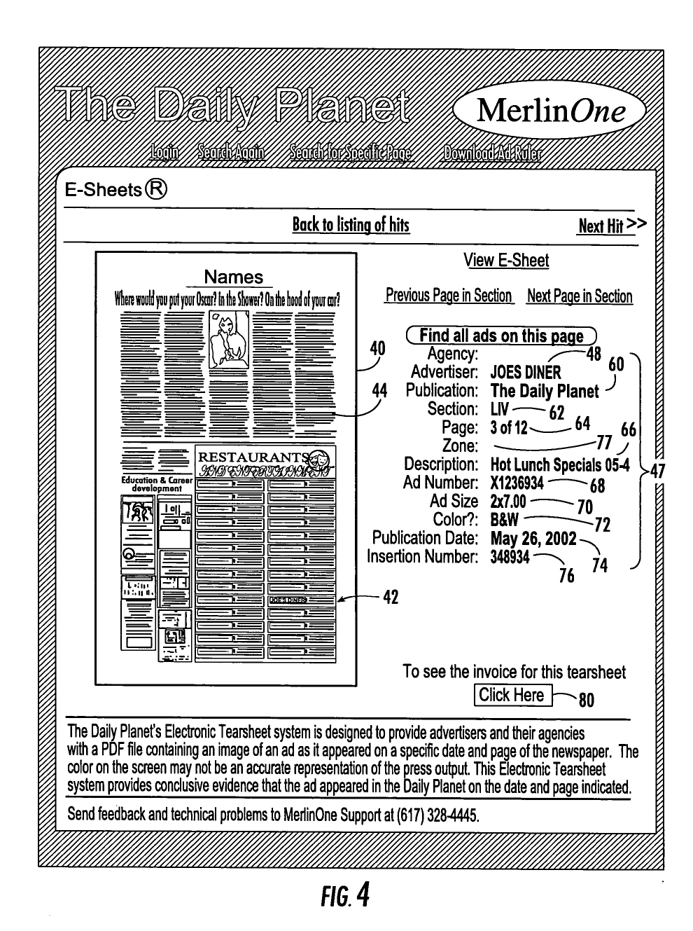

Invoice 20a, so displayed also includes a hyperlink between each line item advertisement and the tearsheet associated with that advertisement. When the hyperlink is activated, the tearsheet is displayed. Thus, by clicking on line item 22d, FIG. 3, for example, tearsheet 40, FIG. 4 is displayed including the advertisement 42 as it actually appeared on the page of the publication 44. Preferably, tearsheet 40 is displayed along with “metadata” 47 about the advertisement including the name of the advertising agency 48 (if any), the name of the advertising company 48, the name of the publication 60, the section of the publication in which the advertisement appeared 62, the page of that section on which the advertisement appeared 64, a description of the advertisement 66, the advertising identifier 68, the size of the advertisement 70, an indication whether or not the advertisement was in color 72, the publication date 74, insertion number 76, and zone 77.

In the prior art, tearsheet 40 was manually cut out of the publication by the publisher and sent to the advertiser along with the other tearsheets corresponding to the line items of invoice 20, FIG. 3. Or, at best, using the system disclosed in U.S. Pat. No. 6,505,173, herein incorporated by this reference, a digital version of the tearsheet, a digital version of the invoice, and a digital version of the advertisement was stored in a single computer file.

In accordance with this invention, however, the tearsheets and invoices are viewable and printable on-line over the Internet and interrelated by links so the advertiser can more easily view, verify, and print the tearsheets and the invoices and interrelate the two. An advertiser can even switch from viewing tearsheet 40, FIG. 4 to viewing invoice 20a, FIG. 3 for that tearsheet by clicking on icon 80, FIG. 4. Typically, publishers such as newspaper personnel are allowed to view the invoices sent out by that publication and all the advertisements run in that publication. Any given advertiser, in contrast, is able to view the invoices sent to that advertiser but not invoices sent to other advertisers.

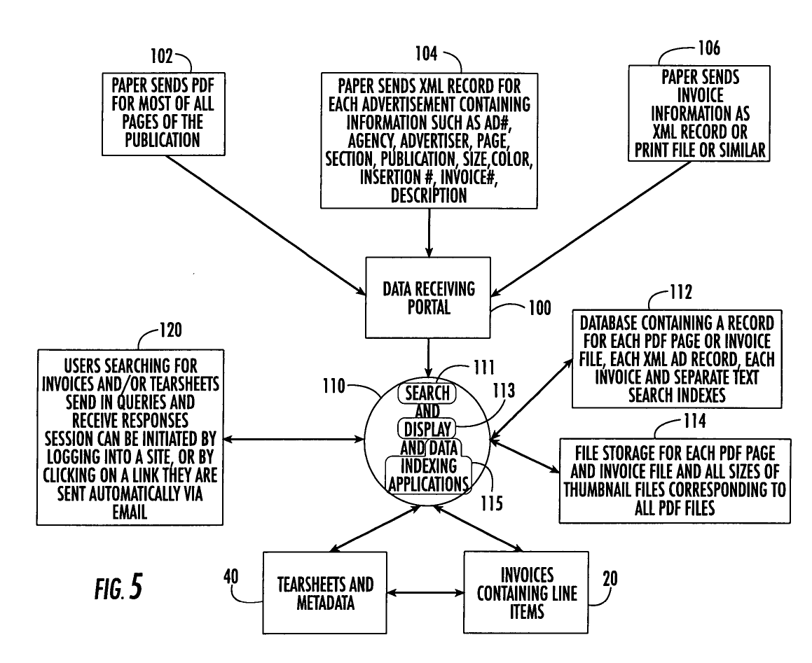

FIG. 5 is an example of an exemplary system and method for interrelating and storing advertisements, tearsheets, and invoices in accordance with the subject invention. Receiving portal or other means 100 is configured to receive, typically from publishers, electronic files representing the pages of a publication 102, electronic records of advertisements 104, electronic records of invoices 106, and/or optionally, electronic records of other types of supporting documentation. Means or engine or system 110 is responsive to receiving portal 100 and is configured to electronically interrelate and store the received electronic files representing the pages of the publication, the records of the advertisements, and the records of the invoices. A search engine or routine or group of routines or function 111 is configured to search invoices and/or tearsheets and display routine 113 is configured to display invoices and tearsheets in a way that interrelates an invoiced line item with a tearsheets as discussed above with reference to FIGS. 3 and 4.

Typically, the electronic files representing the pages of the publication 102, FIG. 5 are a separate PDF file for selected pages of a publication (typically, those pages containing advertisements). In the same example, the electronic record 104 of an advertisement is an XML record or printer file containing metadata about the advertisement including an advertisement identifier, the name of the advertiser, and the other information discussed above with respect to FIG. 4. Electronic record 106, FIG. 5 is typically an XML record of the invoice. The data and indexing functions 115 of engine 110 store each XML record in database 112 which includes a record for each PDF page, each invoice file, and each advertisement record, and search indexes. Engine 110 also populates database 114 with each PDF page and invoice file and all sizes of thumbnail files corresponding to all PDF files. Display routine or means or function 113 displays the found invoice in a way that interrelates the invoice line items with the correct tearsheet as discussed above.

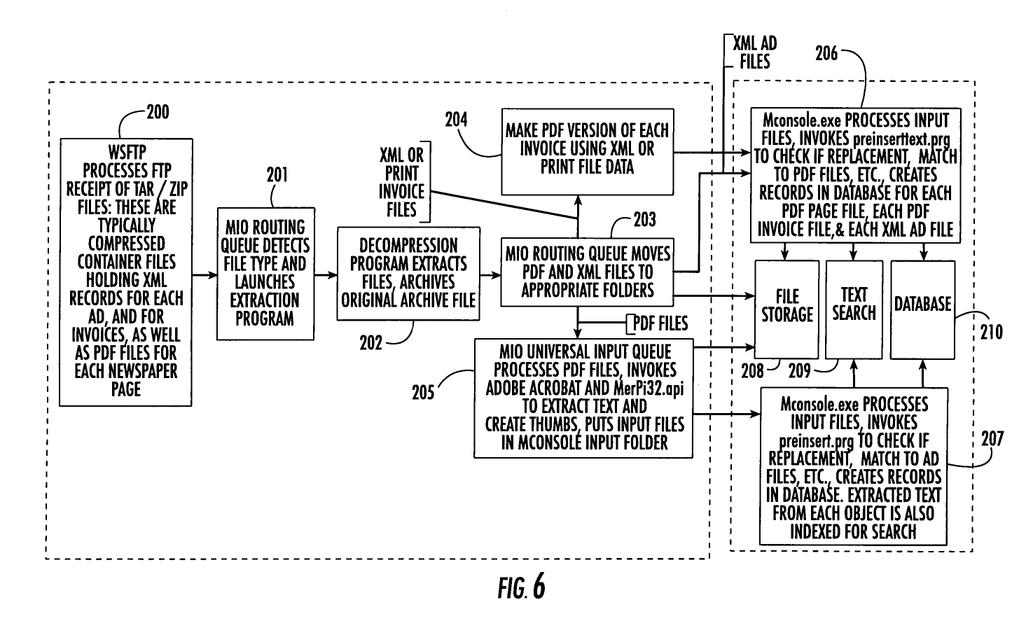

Typically, newspapers originate files, or groups of files packaged in any of several standard compressed file formats and these files are typically sent to the inventive website of this invention via FTP, step 200, FIG. 6. These compressed package files are detected by a software process which routes them to the appropriate decompression utility, step 201. The file are extracted from the package file, step 202 and sent to another routing queue governed by input/output processing (MIO), step 203.

If invoice data is detected, it is routed to a process that creates a PDF form of the invoice information, step 204 and then sends it (the PDF and extracted advertisement numbers and advertiser or agency numbers) to a process, step 206, that parses the information, creates corresponding thumbnail images, puts them into the file storage, step 208 and creates records in the database 210.

If XML advertisement information is detected, then MIO in step 203 sends it to a process that parses the information, step 206 and creates appropriate database records as shown at 210.

If a page PDF is detected, MIO at step 203 sends it to a process, step 205 that creates corresponding thumbnails, extracts all text on the page, sends the thumbnail files and PDF files to file storage 208, and objects are further sent to the Mconsole process, step 207 which indexes all extracted text as shown at 209, creates database records and can modify or replace already existing records in database 210.

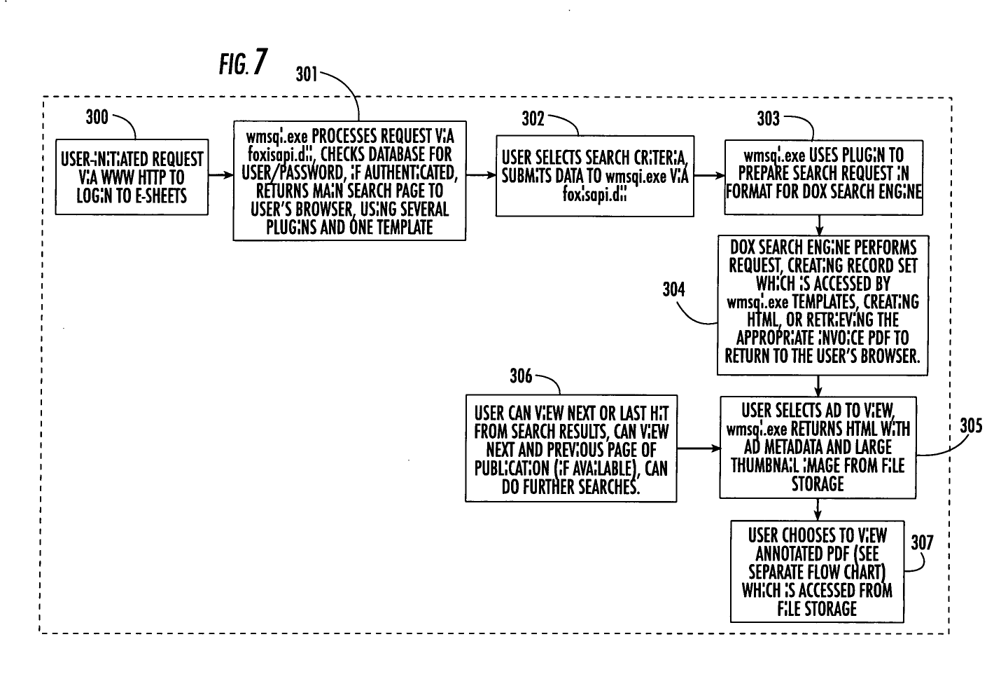

A user, typically but not limited to an advertiser, and agency, or a newspaper, accesses the system via the World Wide Web step 300, FIG. 7. A user can also access the system by clicking on a link embedded in an email they are automatically sent.

The system checks to see if the user is authorized to access the system, makes notes of the restrictions of what they can see, then allows them into the site, step 301. Next the user can elect to search for an advertisement or an invoice, step 302 and submits search criteria (see FIG. 1). These search criteria are received by a process called WMSQL, step 303 which formats the request to be applied against a DOX search engine, step 304 which then executes the search and can return the User either an HTML list of responses, or a PDF of an invoice, or an HTML page with thumbnail and metadata in the case of an advertisement, step 305, or an annotated PDF of a page, step 307. In the case of a tearsheet, a user can also elect to view the adjacent pages, step 306.

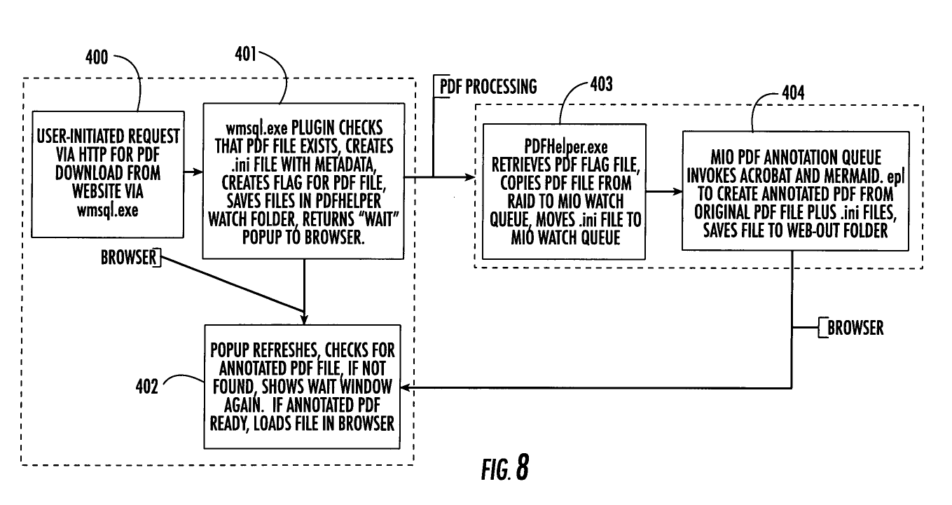

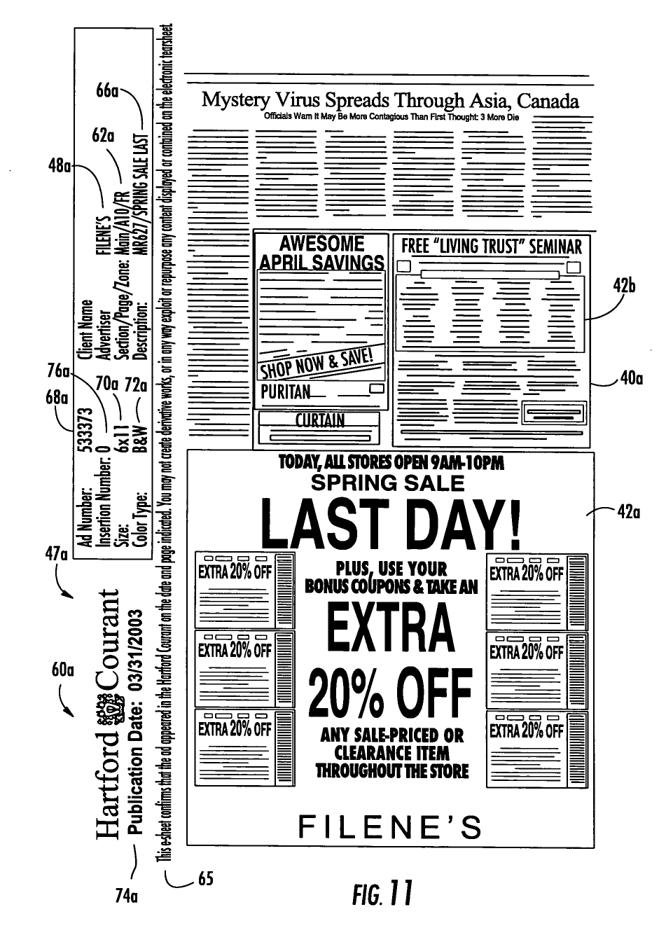

FIG. 8 describes the process by which metadata is stitched onto the left edge of the PDF version of the tearsheets as shown in FIG. 11. This is an on-demand process, and is initiated by a user request, step 400 for the highest resolution version of a particular tearsheet. A software process is initiated, step 401 that prepares the appropriate PDF file and the corresponding metadata for processing, then returns to the user a repeating message, step 402 that the PDF is being prepared. Another process called PDFHelper.EXE, step 403, grabs a copy of the appropriate PDF file and the file containing the metadata and feeds it to an MIO PDF Annotation Queue, step 404 that actually creates the composite PDF shown in FIG. 11 containing both the page requested as well as the metadata relevant to that advertisement on that page. Once completed, this file is served back to the user, terminating the message referred to in step 402.

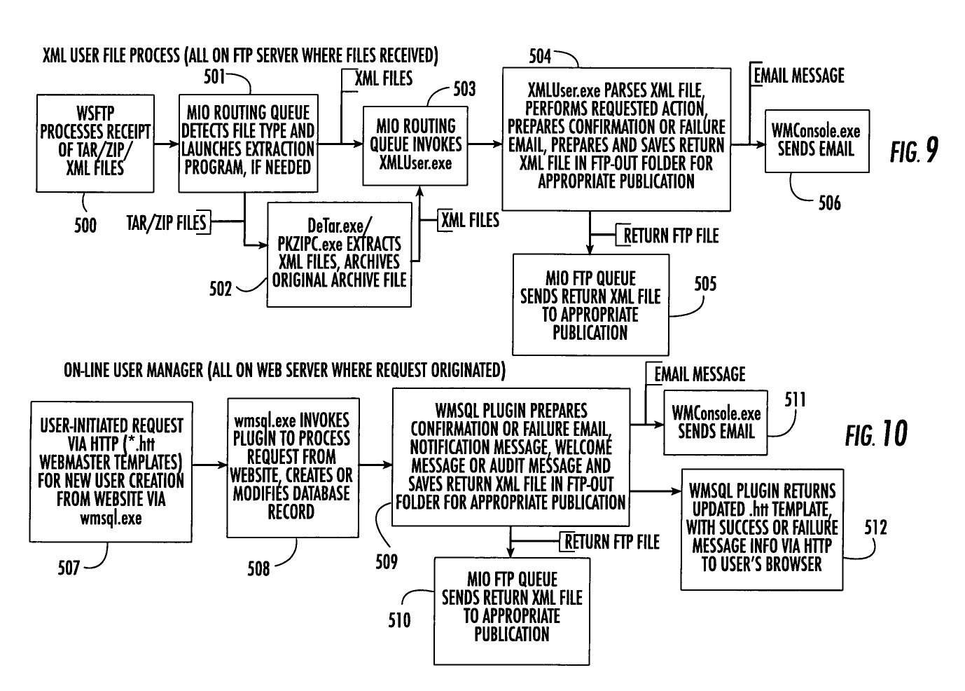

FIGS. 9-10 describe how a newspaper administrator can cause the system to add new users, change the access of users, re-send email notifications, add or correct or delete records of various types. These actions can occur in one of two ways: either by bulk file submission depicted in FIG. 9 or via a web browser interface depicted in FIG. 10.

In FIG. 9, a newspaper or magazine sends via FTP either individual XML files or a compressed file containing several XML files which are received at step 500. An MIO queue, step 501 examines the incoming files and determines if they are compressed files, in which case they are uncompressed, step 502 and as XML files proceed at step 503 to XMLUser.EXE, step 504 which parses the request (for any of the items listed above, or additional items), executes it, prepares return data if appropriate, step 505, and sends confirmation or failure emails if required, step 506.

In FIG. 10, a newspaper or magazine users log in to the site and initiate a request via a web page, step 507. WMSQL processes the request, step 508 and proceeds to another software process, step 509 which prepares the appropriate response to the action, which may include return XML files, step 510, emails, step 511, and will return an HTTP page to the users web browser to indicate and confirm the outcome of the operation, step 512.

FIG. 11 shows tearsheet 40a with advertisements 42a-c and the metadata 47 for advertisement 42a stitched onto the left edge of the PDF version of tearsheet 40a by the process described with respect to FIG. 8 in order to provide a more informative tearsheet for the user including the publisher's logo as shown at 60a and legal requirements as shown at 65. Tearsheet 40a is not stored this way, however. Instead, metadata 47a is stitched onto the stored PDF version of the tearsheet only at the time of display after a user has clicked on the invoice line item associated with the advertisement 42a.

The resulting system and method of this invention thus uniquely interrelates and stores advertisements, tearsheets, and invoices and better utilizes the Internet and the features of a website to provide advertisers with a new way to associate invoice line items with advertisements and tearsheets. The invention makes it easier for advertisers to verify that an advertisement appeared in a publication as requested and as invoiced. Also, tearsheets viewable on-line are provided along with metadata related to an advertisement on the tearsheet.

Also, advertisers can use the subject invention to more easily monitor a competitor's advertisements. Also, the system and method of this invention also allows publishers to more easily monitor advertisers using competitive publications.

The website of this invention features the ability to search for invoices and automatically provides a hyperlink between each invoice line item and the corresponding tearsheet for that line item. Using the website, advertisers can now associate, check, and verify that their advertisements appeared in a given publication as requested and as invoiced in a much easier and convenient fashion. And, the same system which archives the invoices, the advertisement information, and the tearsheets now makes it possible for an advertiser to more easily monitor a competitor's advertisements and also makes it possible for a publisher to more easily monitor advertisers using competitive publications.

In the examples above, the invoice line items correspond to tearsheets. In other applications and in other industries, the system and method of this invention can be used to correlate, by links, invoice line items with supporting documentation for the invoiced line item, for example, a purchase order, a statement of work, other contractual documentation, a picture of a product invoiced, a specification, and the like. Thus, a user may be presented with an invoice and, upon clicking on an invoiced line item, the user is automatically presented with, for example, the purchase order relating to that invoiced line item and/or a picture of the product invoiced. Thus, supporting documentation other than tearsheets can be linked to invoice line items in accordance with this invention.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A website comprising:
a search web page configured to search for invoices and to display a web page including a screen displaying all found invoices by number;
hypertext links between each found invoice and a corresponding individual invoice which, when activated, displays a web page displaying the individual invoice selected from the found invoices including line items for an advertisement in a publication each linked to a tearsheet corresponding to the individual invoice, said line items including an advertisement identifier, the publication date, the publication, the advertiser, and the cost; and
hypertext links between each line item and a corresponding tearsheet which, when activated, displays a web page with the tearsheet along with metadata regarding the tearsheet, said metadata including the name of the advertiser, the publication, the section, the page, a description, an advertisement identifier, the advertisement size, and the publication date.

2. A website comprising:
a search web page configured to search for invoices and to display a web page with at least one found invoice summary;
a link between the at least one found invoice summary and an invoice which, when activated, displays a web page with an invoice including at least one line item for an advertisement in a publication; and
a link between the at least one line item and a tearsheet for the advertisement which, when activated, displays a web page with the tearsheet along with metadata regarding the tearsheet.

3. The website of claim 1 in which the links are hypertext links.

4. The website of claim 1 in which the line item includes an advertisement identifier, the publication date, the publication, the advertiser, and the cost.

5. The website of claim 1 in which the metadata regarding the tearsheet includes the name of the advertiser, the publication, the section, the page, a description, an advertisement identifier, the advertisement size, and the publication date.

6. The website of claim 1 in which the website is searchable by publication and/or by advertiser.

7. The website of claim 1 in which the tearsheet includes a link to the invoice which is displayed when the link is activated.

8. The website of claim 7 in which the link is activated by an icon.

9. The website of claim 1 which includes a screen displaying all found invoices by number.

10. The website of claim 9 which further includes a screen displaying an individual invoice selected from the found invoices.

11. The website of claim 10 in which the individual invoice includes line items each linked to a tearsheet corresponding to the invoice.

12. A website comprising:
a search web page configured to search for invoices and to display a web page with at least one found invoice summary;
a link between the at least one found invoice summary and an invoice which, when activated, displays a web page with an invoice including at least one line item for an advertisement in a publication, said line item including an advertisement identifier, publication date, publication name, advertiser name, and a cost; and
a link between the at least one line item and a tearsheet for the advertisement which, when activated, displays a web page with the tearsheet along with metadata regarding the tearsheet.

13. The website of claim 12 in which the links are hypertext links.

14. The website of claim 12 in which the tearsheet is displayed with the name of the advertiser, the publication, the section, the page, a description, an advertisement identifier, the advertisement size, and the publication date.

15. The website of claim 12 in which the website is searchable by publication and/or by advertiser.

16. The website of claim 12 in which the links are activated by icons.

17. The website of claim 12 in which the metadata includes an advertisement identifier, the name of the advertiser, the publication, the section, the page, a description, the advertisement size, and the publication date.
